(19) United States
(12) Patent Application Publication
(10) Pub. No.: US 2013/0155495 A1
(43) Pub. Date: Jun. 20, 2013

(54) LENS FOR ABSORBING INFRARED LIGHT AND LENS MODULE HAVING SAME

(71) Applicant: CHUNG-PEI WANG, Tu-Cheng (TW)

(72) Inventor: CHUNG-PEI WANG, Tu-Cheng (TW)

(73) Assignee: HON HAI PRECISION INDUSTRY CO., LTD., Tu-Cheng (TW)

(21) Appl. No.: 13/426,625

(22) Filed: Mar. 22, 2012

(30) Foreign Application Priority Data
Dec. 15, 2011 (TW) 100146655

(51) Int. Cl. G02B 13/14

(52) U.S. Cl. 359/356

(57) ABSTRACT

A lens module includes a lens barrel and a lens received in the lens barrel. The lens includes an image-side surface and an object-side surface, and is configured for converging or diverging light from the object-side surface to the image-side surface. The lens is made by a composition of raw materials which absorb the infrared element of the light passing therethrough.

### BACKGROUND

1. Technical Field

The present disclosure relates to lens modules and, particularly, to a lens module having a lens for absorbing infrared light.

2. Description of Related Art

Lens modules may include a lens, a filter, and an image sensor. The filter is positioned between the lens and the image sensor, and is used for reflecting or absorbing infrared light while allowing the passage of visible light. However, the employment of the filter increases not only the cost but also the size of the lens module.

Therefore, it is desirable to provide a lens module, which can overcome the limitations described.

### BRIEF DESCRIPTION OF THE DRAWINGS

FIG. 1 is a cross-sectional schematic view of a lens module in accordance with an exemplary embodiment.

FIG. 2 is an isometric view of a lens of the lens module of FIG. 1.

### DETAILED DESCRIPTION

Embodiments of the disclosure will be described with reference to the drawings.

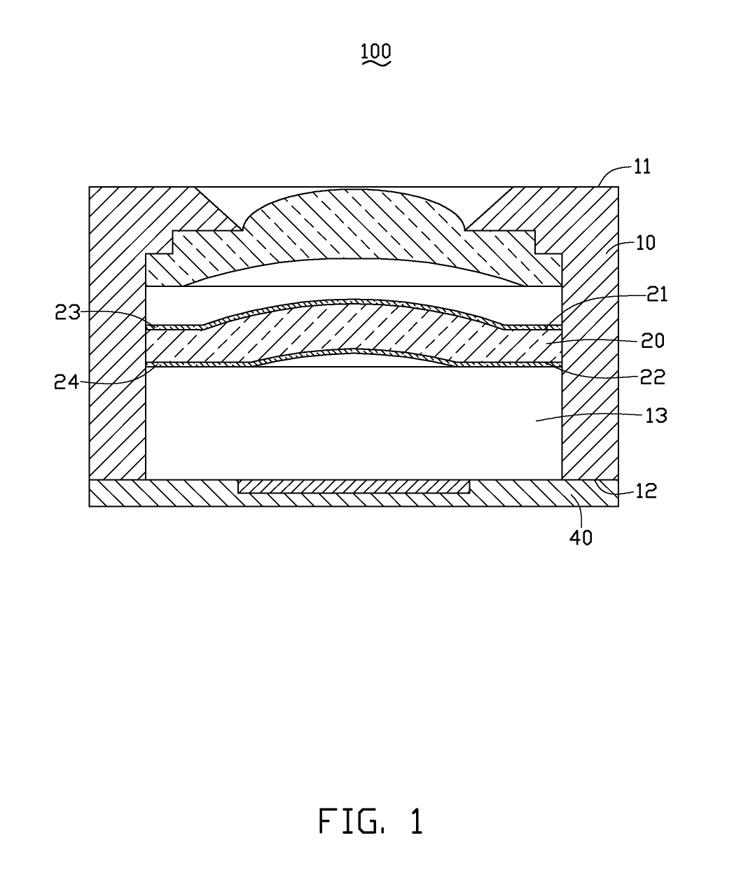

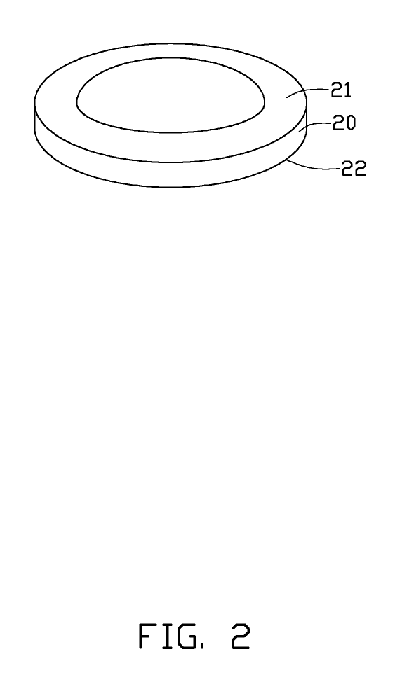

Referring to FIGS. 1-2, a lens module 100, according to an exemplary embodiment, includes a lens barrel 10, at least one lens 20, and an image sensor 40. Light coming into the lens barrel 10 penetrates the at least one lens 20, and images on the image sensor 40.

The lens barrel 10 is tubular and includes an object-side end 11 and an image-side end 12 opposite to the object-side end 11. The lens barrel 10 defines a substantially tubular receiving room 13 extending through the object-side end 11 and the image-side end 12. In this embodiment, the lens barrel 10 is made of light-shielding/opaque/black material(s).

The at least one lens 20 is spherical or aspherical, and is configured for converging or diverging light passing therethrough. The at least one lens 20 is received in the receiving room 13, and includes an object-side surface 21 facing the object-side end 11 and an image-side surface 22 facing the image-side end 12.

The at least one lens 20 is formed by melting a composition of raw materials and cooling the melted composition. The at least one lens 20 is to absorb infrared light out of all light passing therethrough. The composition of raw materials includes 40-75 by percentage weight (wt %) of P₂O₅, 10-28 wt % of Al₂O₃, 3-8.5 wt % of CuO, and 0-5 wt % of B₂O₃. The total of P₂O₅ and Al₂O₃ is over 70 wt %. It is to be understood that the composition of raw materials can be other materials or other weights, and the lenses formed by such composition of raw materials can still absorb infrared light passing therethrough.

In this embodiment, the lens module 100 includes two lenses 20. The two lenses 20 are received in the receiving room 13 aligned along an optical axis of the lens module 100. One of the two lenses 20 (the outer lens 20) is close to the object-side end 11, and the other lens 20 (the inner lens 20) is close to the image-side end 12. The inner lens 20 is formed by the composition of raw materials which can absorb infrared light. The outer lens 20 is made of plastic, glass, or other transparent materials. The two lenses 20 are aspherical.

An anti-reflection film 23 is coated on the object-side surface 21 of the inner lens 20. An infrared filtering film 24 is coated on the image-side surface 22 of the inner lens 20. The anti-reflection film 23 provides an enhanced transmissivity for light, and thus less than about 3% of all light entering will be reflected by the anti-reflection film 23. As the infrared filtering film 24 can further filter out the infrared light, less infrared lights will penetrate through the inner lens 20.

The anti-reflection film 23 includes first to fourth layers stacked in a particular order on the object-side surface 21. The odd numbered layers (1 and 3) of the anti-reflection film 23 are made from titanium dioxide (TiO₂) and the even numbered layers (2 and 4) of the anti-reflection film 23 are made from silicon dioxide (SiO₂). The infrared filtering film 24 includes first to fifty fourth layers stacked in a particular order on the image-side surface 22. The odd numbered layers of the infrared filtering film 24 are made from TiO₂, and the even numbered layers of the infrared filtering film 24 are made from SiO₂. The thickness of each layer is governed by the particular optical characteristics required for each of the anti-reflection film 24 and the infrared filtering film 24.

The image sensor 40 is positioned at the image-side end 12 and covers the receiving room 13. The light passing the at least one lens 20 will be directly projected on an imaging surface of the image sensor 40 which converts the light to electrical signals.

Light enters into the lens module 100 from the object-side end 11 of the lens barrel 10 and strikes the at least one lens 20 received in the receiving room 13. The light penetrates the anti-reflection film 23, then the inner lens 20, and then the infrared filtering film 24. The infrared element of all the light passing the anti-reflection film 23 is absorbed by the inner lens 20, and only the light with wavelengths from about 420 nm to about 680 nm penetrate through the lens 20. The infrared filtering film 24 further filters out the infrared light passing through the lens 20.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A lens, comprising:
an image-side surface and an object-side surface opposite to the image-side surface;
wherein the lens is made by an composition of raw materials which absorbing infrared light constituent of lights passing therethrough.

2. The lens of claim 1, wherein the composition of raw materials comprises: 40-75 wt % of P₂O₅, 10-28 wt % of Al₂O₃, 3-8.5 wt % of CuO, and 0-5 wt % of B₂O₃.

3. The lens of claim 2, wherein the total weight of P₂O₅ and Al₂O₃ is over 70 wt %.

4. The lens of claim 1, wherein the lens is spherical or aspherical.

5. A lens module, comprising:
a lens barrel; and
a lens received in the lens barrel, and comprising an image-side surface and an object-side surface opposite to the image-side surface;
wherein the lens is made by an composition of raw materials which absorbing infrared light constituent of lights passing therethrough.

6. The lens module of claim 5, wherein the composition of raw materials comprises: 40-75 wt % of P₂O₅, 10-28 wt % of Al₂O₃, 3-8.5 wt % of CuO, and 0-5 wt % of B₂O₃.

7. The lens module of claim 6, wherein the total weight of P₂O₅ and Al₂O₃ is over 70 wt %.

8. The lens module of claim 5, wherein the lens is spherical or aspherical.

9. The lens module of claim 5, wherein the lens comprises an anti-reflection film coated on the image-side surface.

10. The lens module of claim 5, wherein the lens comprises an infrared filtering film coated on the object-side surface.
